(19) United States
(12) Patent Application Publication
(10) Pub. No.: US 2010/0035684 A1
(43) Pub. Date: Feb. 11, 2010

(54) SYSTEM AND METHOD FOR CONTROLLING MOVEMENT OF A PLURALITY OF GAME OBJECTS ALONG A PLAYFIELD

(75) Inventors: John J. Kotlarik, Green Bay, WI (US); David A. Myus, Greer, SC (US)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: Bay Tek Games, Inc., Pulaski, WI (US)

(21) Appl. No.: 12/537,286

(22) Filed: Aug. 7, 2009

Related U.S. Application Data
(60) Provisional application No. 61/087,404, filed on Aug. 8, 2008.

(51) Int. Cl. A63F 13/00

(52) U.S. Cl. 463/31

(57) ABSTRACT

An amusement game and method that utilize an image sensing device to track and determine the position of a plurality of game objects on a playfield. The amusement game includes an image sensing device, such as a CCD or CMOS camera, that is positioned to view the playfield of the amusement game and track the movement of a plurality of game objects along the playfield. During game play, the control unit may control the movement of one or more of the game objects along the playfield. The control unit receives a series of sequential image scans from the image sensing device and determines the position and movement of the game objects along the playfield. Based upon the detected position of the game objects under computer control, the control unit modifies the control parameters of the game object during game play.

### CROSS REFERENCE TO RELATED APPLICATION

The present application is based on and claims priority to U.S. Provisional Patent Application Ser. No. 61/087,404 filed on Aug. 8, 2008.

### BACKGROUND OF THE INVENTION

The present invention generally relates to an amusement game in which several players operate remote-controlled game objects, such as cars. The game may be coin-operated, but otherwise unattended. More specifically, the present disclosure relates to an amusement game that allows several of the game objects to be player controlled while those not player controlled are controlled by a control unit.

Presently, many different types of amusement games that include player-controlled movable game objects, such as cars, are available. One commercially available and successful amusement game is shown in U.S. Pat. No. 7,402,106. In the amusement game shown and described in the '106 patent, a series of cars are directed along a playfield by players positioned at one of a plurality of control stations. During game play, if less than the maximum number of players are involved, a control unit operates the remaining cars so that all of the cars are involved in each race. Although the control unit in the amusement game functions well in operating the computer-controlled cars during a race, the amusement game required a very large number of sensing devices positioned both above the playfield and along the inner and outer perimeter edges of the playfield to determine the current position of each of the computer-controlled cars. Because of the large number of sensors required to determine the position of the cars during game play, such amusement game was both expensive to manufacture and difficult to maintain. Additionally, information regarding the position and orientation of gaming pieces was inherently low resolution, which greatly limited the ability of the control unit to manipulate game objects on the playfield.

### SUMMARY OF THE INVENTION

The present invention relates to an amusement game and a method of operating an amusement game that includes an image sensing device that is used to monitor game play and relay images to a control unit such that the control unit can control the operation of at least one of the game objects during game play. The amusement game includes one or more image sensing devices that are positioned such that the image sensing device can view the entire playfield of the amusement game. The image sensing device is in operative communication with a control unit and generates image scans of the playfield at a determined frame rate. During operation of the game, each of the image scans may include a visual representation of the game objects as the game objects move over the playfield. Based upon the position of the game objects on the playfield, the control unit can control the operation of at least one of the game objects.

In one embodiment, the control unit records a reference image of the playfield prior to the beginning of the game play. The reference image shows the playfield before any game object is present. From the reference image, a mask can be used to define the area to be searched for cars.

After game play begins, the control unit records a series of sequential image scans and determines the position of the game objects within the current image scan. Preferably, the control unit subtracts the reference image from the current image scan such that only the game objects are left within the composite image. Based upon the composite image, the control unit identifies the location of each of the game objects along the playfield. Preferably, each of the game objects has a different color and the control unit distinguishes between the game objects and determines the position of each of the game objects based upon a color analysis algorithm. Once different blocks of color have been identified by the control unit, the control unit defines the outer edges of the color blocks and calculates the center of mass for each of the color blocks.

Once the location of each of the color blocks has been identified, the control unit determines the angle of orientation of each of the color blocks. Based upon the angle of orientation and the location of the color block along the playfield, the control unit determines the proper speed and steering angle for the game object to move the game object along the playfield. Once these parameters have been calculated, the control unit relays this information to each of the game objects under computer control to guide the game object along the playfield.

### BRIEF DESCRIPTION OF THE DRAWINGS

The drawings illustrate the best mode presently contemplated of carrying out the invention. In the drawings:

FIG. 1 is a front, perspective view of an amusement game that utilizes an overhead image sensing device to detect the movement of a plurality of game objects along a playfield;

FIG. 2 is a schematic view illustrating the position of the image sensing device and a series of sending units relative to the playfield;

FIG. 3 is a top view of the playfield as seen by the image sensing device;

FIG. 4 is a top, graphical illustration of the movement of one of the game objects along the playfield;

FIG. 5 is a mask image that is logically combined with each top view image of the playfield taken by the image sensing device for the purpose of specifying the area of interest of the playfield where detection of player pieces is to occur;

FIG. 6 is a view of the game objects in the composite image scan;

FIG. 7 is a view similar to FIG. 6 including a grid superimposed over the composite image scan; and

FIG. 8 is a flowchart illustrating the method of operation of the control unit in the amusement game.

### DETAILED DESCRIPTION OF THE INVENTION

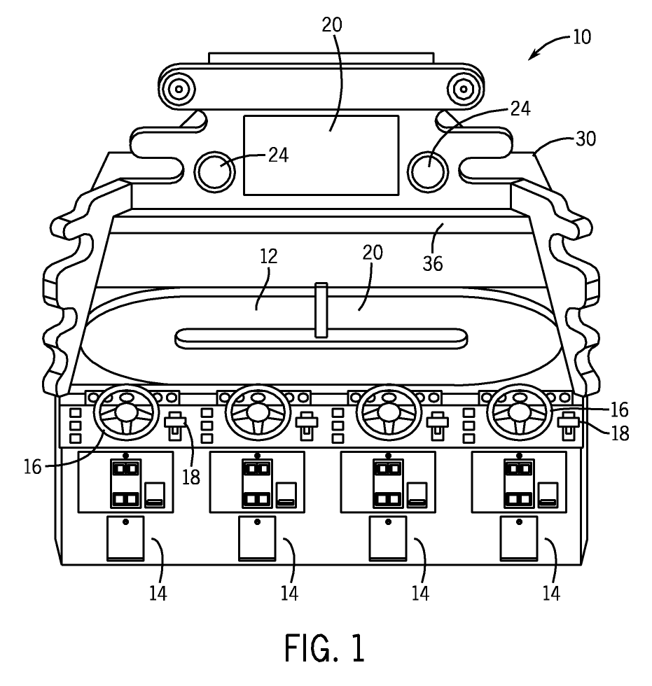

FIG. 1 illustrates a coin-operated, amusement game 10. In this game, up to four players race 1/24^{th} scale remote controlled game objects, such as race cars, on a playfield 12, such as an electric race track. Other types of game objects can be operated in the same manner, and many other playfield and game formats are possible besides racing games. The track is made in an oval shape, consisting of two straight sections joined together by two half-round curved sections. Many other track configurations are possible; this shape was chosen to conserve floor space. The use of an electric track is also optional, since the cars could optionally be powered with batteries or other methods. The playfield 12 allows the cars to have full proportional steering (without slots or other limitations), as well as proportional throttle control. In accordance with the preferred embodiment shown in FIG. 1, the amusement game 10 includes four control stations 14, each of which includes a steering wheel 16 and a throttle 18 to provide the input from a player to a computer control unit to operate the race cars.

The object of the game is to drive the cars around the oval track as many times as possible during the playing time allowed. Each time a car completes a lap, the player is credited with one lap. The lap counts of the four cars are shown on the computer scoreboard 20. A computer-generated announcer's voice announces the progress of the race through speakers 24 and the numbers of the cars in each position. At the end of the time allowed for a game, the car with the most laps is declared the winner.

In the game of the present disclosure, at the end of each race when the playing time is up, all of the cars are driven by the computer control unit to a Start/Finish Line, where the cars generally line up in position for the next race. Then, during the next race, the cars that are not being driven by a paying player are driven by the control unit as “drones”. The ability of the control unit to operate the cars not assigned to a paying player makes the game more interesting and challenging for the players, and prevents the cars from being in the way as stationary “obstacles” on the track. The computer driven drones typically drive laps around the oval track. If the computer controlled cars encounter an obstacle, or are hit by another car and are knocked out of position, the control unit automatically re-orients the drone cars and the cars resume making laps along with the paying players.

For small children and other players who have not acquired the skill needed for competitive racing, the control unit provides an option of computer-assisted driving. In the preferred embodiment of the present invention, three different skill levels are supported, although more or fewer levels are contemplated.

In the Beginner level, the paying player has control of the car's forward and reverse speed, but the control unit controls the car's steering system. Players can move the steering wheel 16 to the left and right, but the steering input is modified by the control unit to help the player. The control unit thus enables the players to drive laps around the track simply by operating the throttle 18. In the preferred embodiment of the invention, in the straight-aways the player is allowed some limited side-to-side movement, to move toward the inside or outside guardrails, but not enough movement to run into the guard rails. If the car is knocked completely out of line by another car, the control unit may give the player control of the steering function long enough to get the car re-oriented.

In the Intermediate level, the player must enter the turns under their own control, but the control unit assists in straightening the car out of turns until the car is proceeding properly down the next straightaway. The length of control while in a straightaway can be set by a game operator to allow for different skill levels at different game installation locations.

In the Expert skill level, players have full control of the steering at all times with no computer-assisted driving. In the Expert level, the maximum forward speed is also set to be the highest since it is assumed that expert players can either handle the car at full speed or are skilled enough to adjust their speed as necessary without help from the computer.

The control unit of the amusement game allows several players to compete at different skill levels in the same race. The computer-assisted driving helps the less-skilled players without giving them an undue or unfair advantage over players who drive as expert drivers. This ensures a fun experience for players of all ages and skill levels.

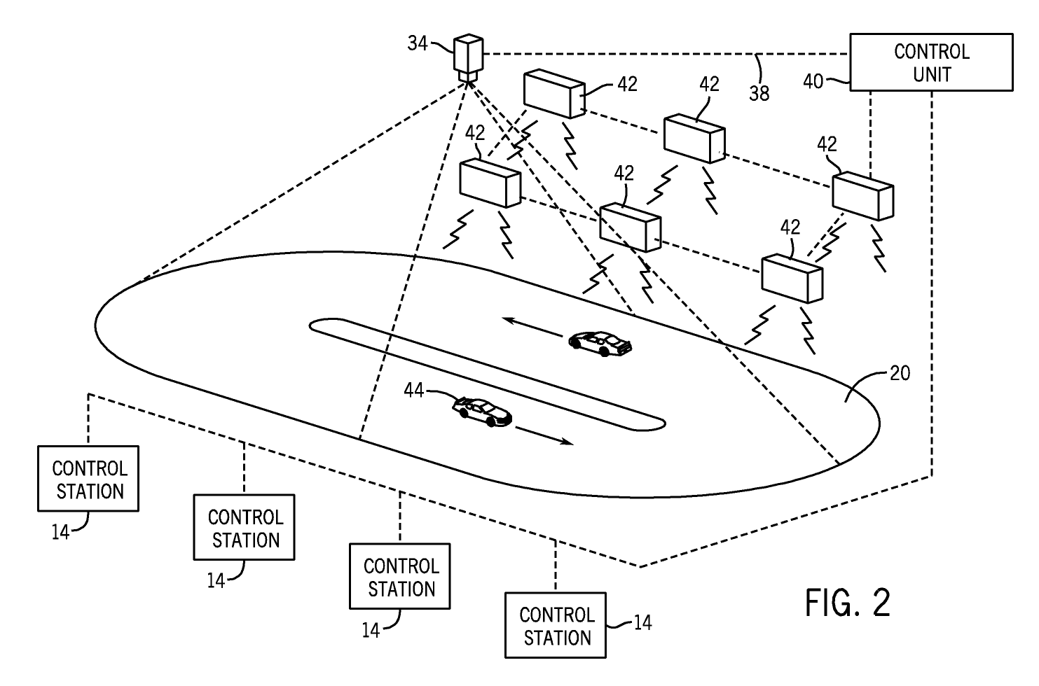

The player controls consist of steering wheel 16 and throttle mechanisms 18, which provide inputs from the control stations 14 to the computer control unit 40, as shown in FIG. 2. In the preferred embodiment, control signals are sent to the game objects 44 from the control unit 40 by digitally encoded command signals modulated on an infrared light (IR) beam sent by the control signal sending units 42. In the embodiment shown, six sending units 42 are utilized, although other numbers of units are contemplated. Each of the game objects 44 is assigned a unique address such that each game object responds only to the digitally coded command signal meant for the game object. Specifically, each command signal includes the object address, steering position and throttle position for the game object. In the embodiment of the invention illustrated, each of the game objects receives the command signal approximately thirty times a second. Other transmission mediums could be used for this purpose, such as radio frequency signals, but IR light is relatively inexpensive and has many benefits, including insensitivity to electrical noise.

As illustrated in FIG. 2, the amusement game 10 further includes an image sensing device 34 that is mounted within the top end 36 of the outer cabinet 30, as shown in FIG. 1, such that the viewing angle of the image sensing device 34 is directed downward onto the playfield 20. The image sensing device 34 is operable to create a series of sequential image scans that are relayed through a communication line 38 to the control unit 40. As will be described in much greater detail below, the image sensing device 34 replaces the plurality of sensors that were previously utilized in similar amusement games to determine the current position of the game objects on the playfield. The use of the image sensing device 34 reduces the amount of wiring and components required for operating the amusement game 10, while allowing for increased resolution and control, enabling new features for enhanced player enjoyment, including faster, more competitive drones, and complex pre- and post-game sequences such as parking in front of driver stations, autonomous pace laps at game start, and post race celebrations.

In the preferred embodiment, the image sensing device 34 is a digital image sensor, such as either a CCD or CMOS image sensor or camera. In the embodiment shown, a CCD or CMOS image sensor is utilized to generate the image scans that are relayed to the control unit 28 through the communication line 38. However, it is contemplated that various other digital image sensors, or other types of analog image sensors, could be utilized while operating within the scope of the present disclosure. As an example, it is contemplated that the image sensing device can process the image scans prior to sending information to the control unit 28. In such an embodiment, the image sensing device 34 would send results to the control unit 40, such as the x, y coordinates of the game object location, rather than the entire raw video image, thereby reducing the bandwidth requirements of the communication line between the image sensing device and the control unit and reducing the processing requirement for the control unit.

In the case of the image sensing device 34 shown in FIG. 1, the image sensor 34 is disposed in a position a specified distance above the center of the playfield 20 with the image sensing surface of the image sensing device 34 facing downward so that the entire area of the playfield 20 can be covered within the field of view of the image sensing device 34. As is well known, the CCD or CMOS camera utilized as the image sensing device 34 includes a multitude of electrical conversion elements as solid state image pickup devices arranged in a matrix. A CCD or CMOS camera picks up an image at a selective specified period. In the embodiment described, the CCD or CMOS camera is operated to capture thirty images per second, although other frame rates are contemplated as being within the scope of the present disclosure.

During operation of the CCD or CMOS camera, electrical signals are generated that have levels corresponding to the amount and color of light received by the respective photo electric conversion element of the CCD or CMOS camera. The electrical signals are received by the control unit 28 and analyzed as will be described below.

Although the embodiment describes utilizing only a single image sensing device 34, it is contemplated that multiple CCD or CMOS cameras could be combined to operate as the image sensing device, depending upon the size of the playfield 20 and resolution required by the amusement game. Further, the use of multiple image sensing devices 34 allows the concept of the present disclosure to be utilized in various different types of games, such as multiple player games that include separate and distinct playfields for each player. In such an embodiment, each playfield may include its own image sensing device and a single control unit could receive the visual images and conduct the game accordingly.

Alternatively, multiple image sensing devices may be required when the size of the playfield is much larger than the viewing field of any individual image sensing device. Likewise, the use of multiple cameras for a single playfield allows for “stereo” images and/or three dimensional tracking for the movement of the game object. The use of multiple image sensing devices allows the concept to be utilized with other types of amusement games.

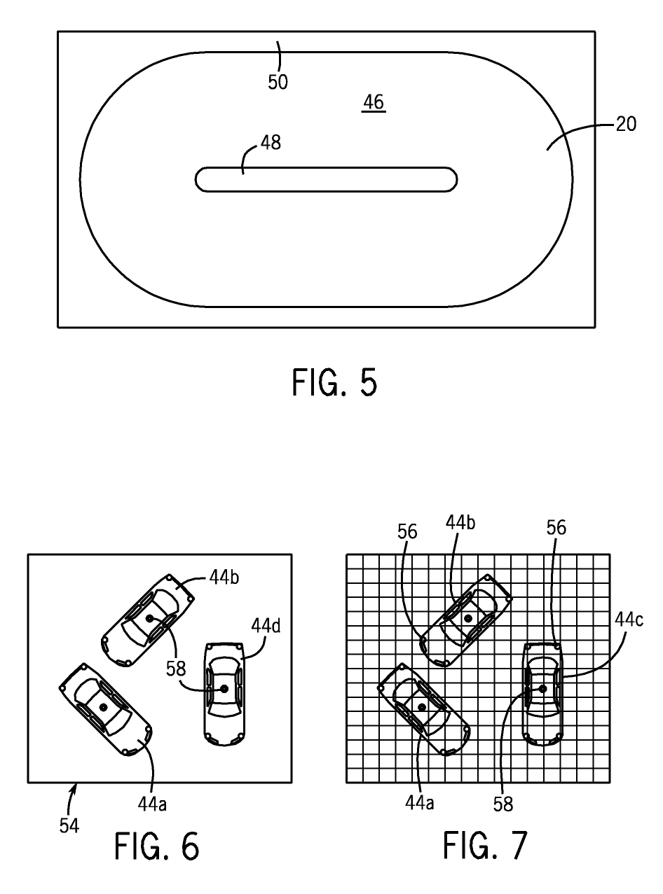

Referring now to FIG. 5, thereshown is an image scan received by the control unit from the image sensing device. The image view of FIG. 5 is of the entire playfield 20 before the operation of the game play. Specifically, FIG. 5 illustrates a mask image 46 created by the image sensing device 34 of the entire playfield 20 before the game play begins and before one of the game objects is positioned over the playfield. The reference image from the image sensing device includes a resolution of 640×480 (VGA) (x=480, y=640), although other resolutions such as 352×288 (x=288, y=640) (CIF) and other, higher resolution formats are clearly contemplated as being within the scope of the present disclosure.

As illustrated in FIG. 5, the mask image 46 is a visual image of the playfield 20 and includes the general orientation of the racetrack of the race car game. The mask image includes the center divider 48 and the outer wall 50 that defines the track for the series of race cars

The image sensing device of the present disclosure creates the electronic image scans at a rate as low as ten frames per second during game play, although this low a frame rate may limit the speed of the cars. In one embodiment of the disclosure, it is contemplated that frame rates between 30 and 60 frames or more per second can be utilized to resolve high speed object motion and to reduce or eliminate blurring. These frame rates are well within current imaging and processing technology capability. The mask image 46 shown in FIG. 5 is taken prior to game play and is used to define the general layout of the playfield 20. The mask image 46 shown in FIG. 5 is logically and'ed with the image scans received by the control unit 40 (FIG. 2) and is used by the control unit 40 to determine which parts of the field of view are to be processed for car identification. An image may be taken of an empty playfield as a reference image for comparison to subsequent image scans to identify the movement of the game objects on the playfield.

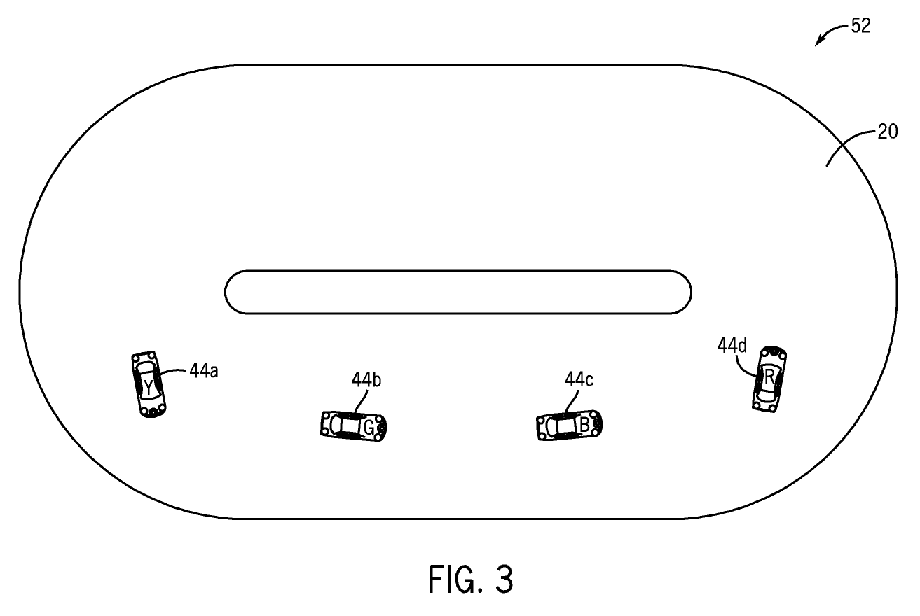

Referring now to FIG. 3, thereshown is an image scan 52 from the image sensing device during game play. In the image scan 52, four game objects 44a-44d are positioned along the playfield 20. As previously described, during normal game play, the individual game objects 44a-44d are guided along the playfield 20 by either a participating player or under control by the control unit. In the embodiment illustrated in FIG. 3, the playfield 20 is a racetrack while the individual game objects are race cars. However, as previously stated, it is contemplated that the playfield could have many other configurations and the game objects could also have other configurations. As an example, the playfield could be some type of sport court, such as a hockey rink or soccer field, and the game object could be individual players. The present disclosure is not meant to be limited to any type of playfield or game object since the configuration of the amusement game could be widely varied. During normal game play with multiple players participating in the gaming experience, each of the game objects 44 is controlled by a player. However, if less than two players are engaged with the amusement game, the control unit controls one or more of the game objects during game play.

For the control unit of the amusement game to control the operation of one or more of the game objects 44, the control unit must utilize image processing techniques to identify both the position of the game objects 44 on the playfield 20 and the direction of movement of the game objects along the playfield.

In the embodiment illustrated in FIG. 3, each of the game objects 44a-44d is a different color. Specifically, in the embodiment shown in FIG. 3, the game object 44a is yellow, the game object 44b is green, the game object 44c is blue and the game object 44d is red. The color of the four game objects correspond to one of the control stations 14 shown in FIG. 1. Thus, a player that approaches the amusement game 10 and selects the red control station 14 will control the red game object 44d.

Although four different colors for the game objects are described in the present embodiment, it is also contemplated that each of the game objects could include another type of distinguishing characteristic that would allow the game objects to be distinguished from each other utilizing image processing techniques. As an example, each of the four game objects could include a different geometric shape included on a top portion of the game object. In any event, each of the game objects includes a distinguishing characteristic that allows an image processing technique to distinguish between the game objects in an image scan similar to that shown in FIG. 3. Optical character recognition may also be used to determine player numbers placed in such a manner as to be visible by the imaging device.

Although various types of image processing techniques are known that could be utilized to isolate the position of the game object relative to the playfield in each of the image scans, in the embodiment of the disclosure shown in the Figures, the system utilizes an image subtraction method. Specifically, the control unit records the image scan 52 shown in FIG. 3 and may subtract the reference image, then logically ands the mask image 46 shown in FIG. 5. When the image processing is completed, only the game objects 44 remain, as shown in FIG. 6. The position of the game objects 44 on the composite image 54 can then be analyzed to determine the position and orientation of the game object relative to the playfield. Once the resulting image 54 has been created for the current image scan, the control unit utilizes an image processing algorithm to determine the location and orientation of the game object as described below.

```
For each frame:
Capture (h=640,v =480)[r,g,b] where r,g,b are 8 bit values (0-255) of red, green and
blue data at each pixel
Initialize segmented image grid GridResult(H=16,V=16)[MajorColor,R,G,B,Y] =0
For each pixel (h,v) in each GridResult (H,V):
If r>g+20 and r>b+20 Then r=255 g=0 b=0 and Increment GridResult(H,V)[R]
If g>r+20 and g>b+20 Then r=0 g=255 b=0 and Increment GridResult(H,V)[G]
If b>r+20 and b>g+20 Then r=0 g=0 b=255 and Increment GridResult(H,V)[B]
If r>g+20 and g>b+20 and |r−g|<25 Then r=255 g=255 b=0 and Increment
GridResult(H,V)[Y]
Next pixel
For each GridResult (H,V):
If GridResult(H,V) R>G+30 and R>B+30 then GridResult(H,V)[MajorColor]=R
If GridResult(H,V) G>G+30 and R>B+30 then GridResult(H,V)[MajorColor]=G
If GridResult(H,V) B>G+30 and R>B+30 then GridResult(H,V)[MajorColor]=B
If GridResult(H,V) R>G+30 and G>B+30 and |R−G|>20 then
GridResult(H,V)[MajorColor]=Y
Next GridResult
Initialize CarBlock (Color=R,G,B,Y)[LL,LR,UL,UR][H,V]]=−1
    //LL,LR=Lower Left;Right; UL,UR=Upper Left;Right
For each Color:
    Find_GameObjectBlocks //horizontal & vertical bounding box detection of
adjacent grids w/same color
Next Color
The thresholds for each color value difference in relation to other colors may be
varied as needed for color discrimination.
```

Once each pixel of the entire screen image has been classified as described above, the control unit determines the position of each of the colored game objects by first defining a game object block for each color. Once a block of color has been identified in the composite image, the control unit creates a bounding box for each of the game objects. Since each of the game objects has a different color, the control unit is able to create a bounding box for each of the game objects within the composite image 54.

Referring now to FIG. 7, the computer control unit develops a grid pattern to help identify the bounding box for each of the game objects. Once the bounding box has been determined by identifying the corner points 56 for each of the game objects 44, the control unit determines the center of each game object by the intersection of two diagonal lines drawn from the four corners of the bounding box. The point at which the intersecting lines meet is shown in FIGS. 6 and 7 as the center point 58. The center point 58 is utilized as a tracking point for each of the game objects for the computerized control of the game object around the playfield. Alternatively, a front of car point may be determined by past motion history or standard pattern recognition means, and used as a tracking point, or a combination of multiple tracking points may be used.

Once the location of each of the game objects has been identified in the image scans 52 shown in FIG. 3, the control unit must then determine the current orientation of each of the game objects as well as the direction of movement of the game object along the playfield 20.

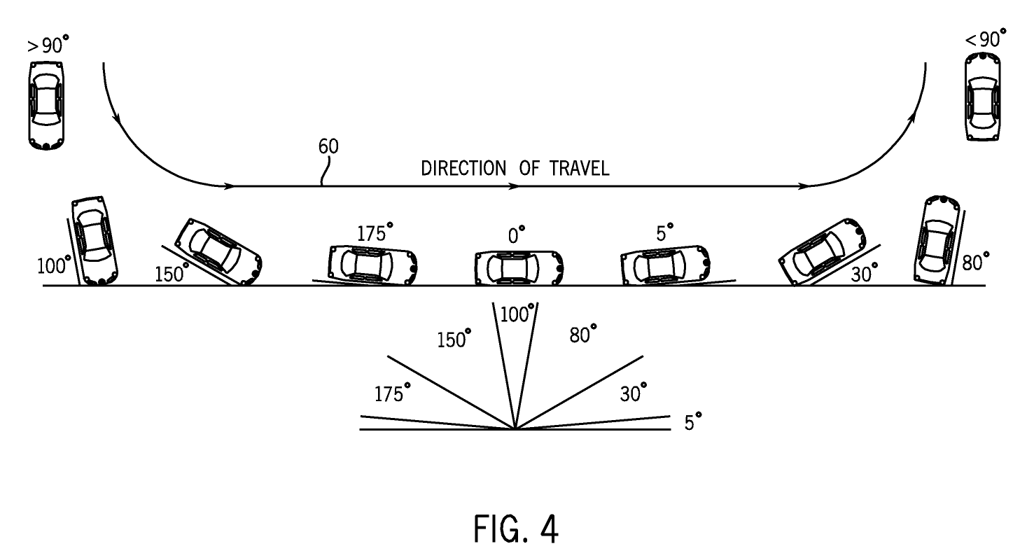

As stated previously, the control unit can identify the position of the game object on the playfield by utilizing image subtraction and color identification. Further, the bounding box and the center point 58 of each of the game objects allows the control unit to determine the angular orientation of the game object. In the embodiment shown in FIG. 4, the game object is shown positioned at various orientations along one-half of the playfield. The angle of the game object is represented between 0° and 180°, where 0° is the correct bearing for the straightaway. It should be understood that for the other half of the playfield, the angle of the game object is converted such that when the game object is located at 150° on either half of the game field, the control unit will carry out the same control function to adjust the angular position of the steering.

In the embodiment illustrated in FIG. 4, the control unit initially assumes that the game object is traveling in the correct direction of travel, namely in the direction illustrated by arrow 60 in FIG. 4. Assuming the game object is traveling in the correct direction, the control unit then calculates the angle relative to the 0° position. Based upon the angle of orientation of the game object and the location of the game object on the playfield, the control unit utilizes a control algorithm to adjust the steering control of the game object to guide the game object along the playfield 20.

In one embodiment, the control unit utilizes a target angle of 0° to control the object in a straightaway and gradually adjusts the position of the wheels to guide the game object around the corners of the track as illustrated.

Set forth below is a portion of the control algorithm utilized by the control unit to control the operation of one of the game objects along the straight portion of the playfield where the steering range is −127 hard left to +127 hard right:

straighten car out - no heading defined
if currentangle>90:
mydiff = 180 - (int)(currentangle);
tempsteer = −5;
if (mydiff > 5) then tempsteer = −10;
if (mydiff > 10) then tempsteer = −20;
if (mydiff > 20) then tempsteer = −45;
if (mydiff > 30) then tempsteer = −60;
if (mydiff > 40) then tempsteer = −85;
if (mydiff > 50) then tempsteer = −100;
else
mydiff = (int)(currentangle);
tempsteer = 1;
if (mydiff > .5) then tempsteer = 10;
if (mydiff > 5) then tempsteer = 20;
if (mydiff > 10) then tempsteer = 35
if (mydiff > 20) then tempsteer = 45;
if (mydiff > 30) then tempsteer = 60;
if (mydiff > 40) then tempsteer =85;

Other values, as well as values modified by current speed or car position on playfield may also be used.

The portion of the control algorithm set forth above controls the movement of the game object along the straight portions of the playfield shown. Various different control algorithms can be utilized to direct each of the computer controlled “drone” game objects along the playfield depending upon various parameters. As an example, the speed and steering functions of the computer controlled cars can be adjusted depending upon the ability level of the other players engaging in the game play. If the control unit determines that the players have relatively high skill, the control algorithm can be adjusted to increase the speed of the drone cars and to cause the drone cars to take a more aggressive line around the playfield. This type of algorithm makes the drones less predictable and more fun to race since the speed of the drones can be adjusted in real time to closely match that of the fastest (and possibly just below the slowest) players.

Referring back to FIG. 3, the specific control parameters for each of the game objects (cars) is set forth below as an illustrated example of the information received by the control unit:
Red car 44d has a 58 degree angle at position x=573 y=220 with steering all the way to the left at −127 to round the turn
Blue car 44c has a 2 degree angle at position x=453 y=134 with steering +10 to straighten out from center
Green car 44b has a 165 degree angle at position x=282 y=122 with steering −20 to straighten in to center
Yellow car 44a has a 127 degree angle at position x=108 y=168 with steering at −100 beginning to straighten from turn

In the embodiment shown in the above description and illustrated in FIG. 3, each of the game objects has a steering range between −127 (hard left) to +127 (hard right). Thus, the control unit can send signals to each of the cars under computer control to adjust the steering angle of the car to guide the car around the playfield. Further, the control unit sends signals to the car including throttle values to control the speed of the car during game play.

During game play, the control unit can compare the position of the car on the playfield and the orientation of the car in the current image scan to the position and orientation of the car in a past image scan. The comparison between the location and position amongst multiple image scans allows the control unit to determine the direction of movement of each of the game objects during game play. Further, the comparison from one image scan to the next allows the control unit to determine the speed of travel and identify the position of the computer controlled cars relative to those being player controlled.

In the above description, RGB values are the actual camera-generated pixel values for each of the three colors. The RGBY values include Y, which is an image processing example of the ability to distinguish more than three object colors using only three captured image input color data values. Other types of color measurement formats other than RGB, such as CMYK or HSV can accomplish the required image processing tasks as well.

As described above, although image subtraction and region of interest masking is described as being one type of image processing technique utilized to identify the position of the game object, various other types of image processing techniques can be utilized while operating within the scope of the present invention. Specifically, any type of imaging processing technique that can identify the tracking point of the game object can be utilized to determine the position of the game object relative to target areas defined on the playfield.

Although the preferred type of image sensor is a CCD or CMOS image sensor, it is also contemplated that a low cost, infrared camera can also be utilized while operating within the scope of the present disclosure. A low cost infrared camera can be utilized to determine differences between play objects and playfields to determine the location of a game object. In another alternate embodiment, a linear sensor array could be utilized where two dimensional resolution is not required. Although various other embodiments, such as an IR camera and a linear array, are specifically set forth, it should be understood that various other types of image sensing devices could be utilized while operating within the scope of the present disclosure.

FIG. 6 is a flowchart generally setting forth the method utilized by the control unit to operate the amusement game utilizing the image sensing device 34 to monitor game play and control the operation of one or more of the game objects during the game play.

Initially, the control unit activates the image sensing device to view the playfield, as shown in step 62. Once the playfield has been viewed, the control unit records the image of the playfield as a reference image in step 64. In addition to the reference image, the control unit creates a mask image for the playfield, as shown in FIG. 5, which generally includes the outer boundaries of the racetrack for the car racing game shown in the preferred embodiment. However, as previously set forth, various other types of amusement games are contemplated other than racing games such that the reference image could have various different configurations. Additionally, various other types of playfield configurations are contemplated as being within the scope of the present disclosure.

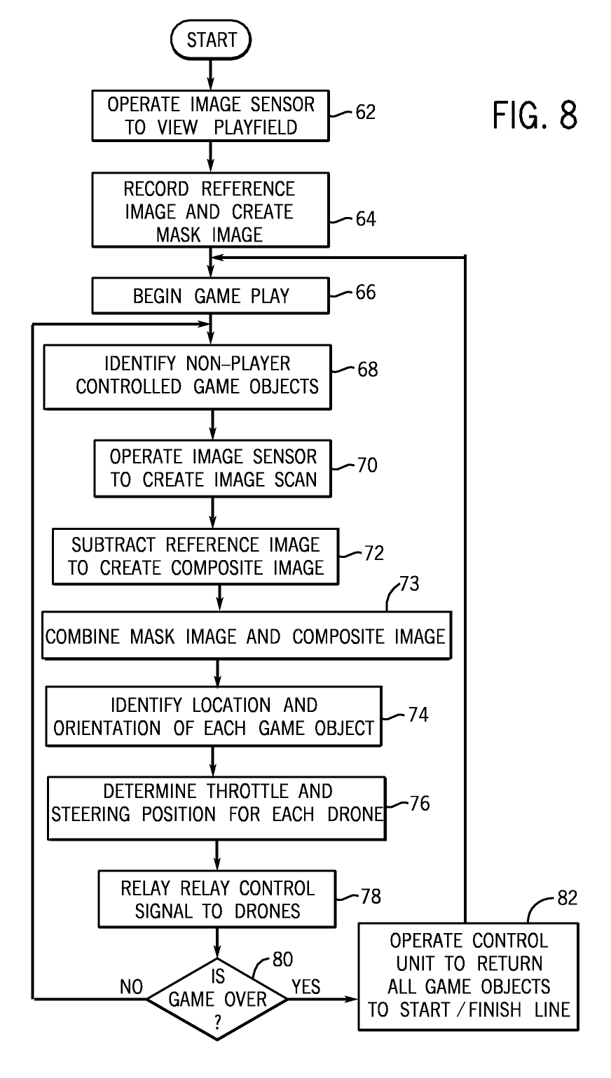

Referring back to FIG. 8, after the reference image and mask image have been recorded and stored by the control unit, the control unit determines whether game play should begin in step 66. Generally, the control unit monitors for the insertion of coins or other monetary payment prior to beginning the game play. Once game play begins, the control unit identifies the number of players involved in the game to determine whether the control unit needs to operate one of the game objects as a “drone”, as illustrated in step 68. If the control unit determines that all of the game objects are being operated by a player, the control unit does not need to actively control any of the game objects as a drone.

Once the game play has begun, the control unit operates the image sensing device to create a series of sequential image scans of the playfield at a pre-defined rate, as shown in step 70. In the embodiment of the invention described, the image sensor operates to generate at least thirty images per second, although a higher or lower frame rate could be utilized while operating within the scope of the present disclosure.

For each of the image scans created by the image sensor, the control unit compares the image scan to the reference image in step 72. As described previously, one method of comparing the image scan to the reference image is to subtract the reference image from the current image scan to create a composite image scan in which the only remaining elements are the individual game objects. In step 73, the mask image is logically and'ed with the composite image to define the region of interest where cars are to be identified.

In step 74, the control unit identifies the location and the orientation of each game object utilizing the system and method previously described. In the preferred embodiment shown and described in the present disclosure, the location and orientation of each of the game objects is determined based upon a color sensing technique. In such embodiment, each of the game objects has a different color such that the control unit can identify the location and identity of each of the objects based upon identifying blocks of color. However, it is contemplated that other methods can be utilized, such as including geometric shapes on each of the game objects such that the control unit can identify the location of each of the individual game objects based upon the geometric shape contained on the game object. Optical character recognition may also be used to determine player numbers placed in such a manner as to be visible by the imaging device.

Once the location and orientation of each of the game objects is identified, the control unit determines the desired throttle and steering position for each of the drones currently under computer control, as illustrated in step 76. As described previously, the control unit can utilize various algorithms to determine the speed and aggressive nature of the steering to create a game play that is both challenging for advanced players yet enjoyable for novice players.

Once the throttle and steering position control signals have been calculated, the control unit relays the signals to the drones, as shown in step 78. In the embodiment shown in FIG. 2, the control signals are sent to each of the drones by the plurality of sending units 42 positioned above the playfield 20. In the embodiment shown in FIG. 2, six sending units 42 are positioned around the playfield such that the combination of the sending units can send signals to the game objects located anywhere on the entire playfield 20. It is contemplated that fewer or less sending units 42 could be utilized depending upon the configuration of the playfield 20. In either case, the design criteria is to provide complete coverage over the playfield 20.

Referring back to FIG. 8, once the control signals have been relayed to the drones in step 78, the control unit determines in step 80 whether the game play has been completed, either by counting number of laps of the lead car, or by a predetermined game length timeout. If the game play has not yet been completed, the control unit returns to step 70 to continue to operate the image sensor to create image scans.

As can be understood by the flowchart of FIG. 8, the control unit continues to obtain image scans during the entire game play. Each of the image scans provides the current position of each of the game objects along the playfield. Since the control unit operates to calculate the position of the game objects multiple times per second, the control unit can actively control each of the game objects to guide the game objects along the playfield without contacting the outer perimeter walls of the playfield.

If the computer control unit determines in step 80 that the game has been completed, the control unit operates to return all of the game objects to the Start/Finish Line, as indicated in step 82. Alternatively, the control unit directs all non-winning cars to an edge of the track, and performs one or more victory laps, or other celebratory sequences, with the winning car, then moves all cars in front of the corresponding player control stations. Once the game has been completed, the control unit takes over control of all of the game objects, even if one of the game objects was player controlled during game play. Based upon the control units control of the series of game objects, the control unit returns to step 66 to determine if another game needs to be played. Since the control unit returns each of the game object to the Start/Finish Line, at the beginning of the next game play, all of the game objects begin from a common position.

Although the embodiments shown in the Figures illustrate a racing game having a series of race cars, it is contemplated that various other types of amusement games could be utilized while operating within the description of the present disclosure. As an example, it is contemplated that other games, such as soccer, hockey, horse racing or other similar games in which a player controls the movement of a game object along a playfield could be utilized within the scope of the present disclosure. In each of these other alternate embodiments, the image sensing device monitors the movement and position of the game object such that the control unit can analyze the image scans from the image sensing device and control one or more of the game objects during the game play. Although specific examples are set forth in the disclosure, it should be understood that various other types of amusement games could be utilized while operating within the scope of the present disclosure. The disclosure of the present invention is not meant to be limiting as to the type of amusement games possible, but rather is meant to be illustrative of currently contemplated amusement games that could operate within the scope of the present disclosure.

We claim:

1. A method of operating an amusement game having a plurality of game objects moving along a playfield, the method comprising the steps of:
positioning an image sensing device in view of the playfield;
operating the image sensing device to generate an image scan of the playfield and the plurality of game objects;
receiving the image scan in a control unit;
determining the current position of each of the plurality of game objects relative to the playfield; and
operating the control unit to automatically control the movement of at least one of the plurality of objects based on the current position of the game object.

2. The method of claim 1 further comprising the steps of:
operating the image sensing device to capture a plurality of sequential image scans;
determining the direction of movement of at least one of the game objects based upon the sequential image scans; and
controlling the movement of the at least one game objects based upon the current position of the game object and the direction of movement of the game object.

3. The method of claim 2 wherein the step of determining the current position of each game object comprises the steps of:
recording a reference image of the playfield from the image sensing device before the beginning of game play;
creating a mask image of the playfield to identify regions of interest for the game objects;
subtracting the reference image from each image scan to create a composite image scan including only the game objects; and
combining the resulting image with the mask image to determine the current position of each game object relative to the playfield.

4. The method of claim 1 wherein each of the game objects includes a unique identifier, wherein the step of determining the current position of each of the game objects comprises the steps of:
operating the image sensing device to obtain a current image scan of a playfield;
subtracting a reference image from the current image to create a composite image scan including only the game objects;
determining the position of the plurality of game objects in the composite image scan; and
identifying each of the plurality of game objects based upon the unique identifier.

5. The method of claim 4 wherein the unique identifier is color.

6. The method of claim 1 wherein the step of controlling the movement of the game objects includes the steps of:
comparing the current position of each of the game objects to parameters of the playfield; and
sending a control signal to each of the game objects to modify the steering orientation of the game object.

7. The method of claim 1 wherein the image sensing device is a CMOS or CCD camera.

8. A method of operating an amusement game having at least one computer controlled game object and at least one player controlled game object moving along a playfield during game play, the method comprising the steps of:
positioning an image sensing device in view of the playfield;
operating the image sensing device to capture a plurality of sequential image scans during game play;
relaying the plurality of image scans to a control unit;
determining the location of the player controlled game objects relative to the playfield;
determining the location of the computer controlled game object relative to the playfield; and
operating the control unit to control the movement of the computer controlled game object.

9. The method of claim 8 wherein the image sensing device is a CCD or CMOS camera.

10. The method of claim 8 wherein the step of determining the location of the game objects comprises:
recording a reference image of the playfield from the image sensing device prior to game play;
subtracting the reference image from each image scan to define a composite image scan;
determining the location of each of the game objects in each of the composite image scans; and
determining the movement of each of the game objects in each image scan relative to the prior image scan.

11. The method of claim 10 further comprising the steps of:
analyzing each of the composite image scans to identify each of the game objects based on a color of the game object; and
determining an orientation of the game object in each composite image scan.

12. The method of claim 10 wherein the identity of each of the game objects in each image scan is determined utilizing color metrics.

13. The method of claim 8 further comprising the steps of:
terminating the game play at the end of a specified period;
operating the control unit to automatically control the operation of both the computer controlled game objects and the player controlled game objects; and
controlling the movement of the game objects to return the game objects to a starting position prior to the beginning of another game play.

14. The method of claim 10 further comprising the steps of:
identifying regions of color in the composite image scans, the regions of color each being one of a plurality of colors;
defining a game object block for each of the regions of color;
determining an orientation for each of the game object blocks; and
identifying each of the game object blocks to one of the game objects based on color.

15. An amusement game comprising:
a playfield;
a control unit;
a first game object movable along the playfield by a player during game play;
a second game object movable along the playfield by the control unit during game play;
an image sensing device positioned to view the entire playfield and operable to create a plurality of sequential image scans of the playfield during game play;
wherein the control unit controls the movement of the second game object along the playfield based upon a sensed location of the second game object on the playfield and a sensed position of the first game object along the playfield.

16. The amusement game of claim 15 wherein the first game object and the second game object each include a unique identifier.

17. The amusement game of claim 15 wherein the unique identifier is color.

18. The amusement game of claim 16 wherein the control unit operates to determine the sensed location of the first game object and the second game object in each of the image scans based upon the unique identifier.

19. The amusement game of claim 15 wherein the image sensing device is a CMOS or CCD camera.

20. The amusement game of claim 15 further comprising a plurality of sending units in communication with the control unit, wherein the control unit relays control signals to both the first game object and the second game object through the sending unit.
